(19) United States
(12) Patent Application Publication
(10) Pub. No.: US 2022/0376417 A1
(43) Pub. Date: Nov. 24, 2022

(54) WIRE-CLAMPING CONNECTOR ASSEMBLY

(71) Applicant: CviLux Corporation, New Taipei City (TW)

(72) Inventors: WEN-HSIN HUANG, New Taipei City (TW); CHIN-CHIANG CHEN, New Taipei City (TW)

(21) Appl. No.: 17/577,163

(22) Filed: Jan. 17, 2022

Related U.S. Application Data
(60) Provisional application No. 63/191,371, filed on May 21, 2021.

(51) Int. Cl. H01R 12/79; H01R 12/70; H01R 13/506; H01R 13/424

(52) U.S. Cl. CPC H01R 12/79; H01R 12/707; H01R 13/506; H01R 13/424

(57) ABSTRACT

A wire-clamping connector assembly includes a wire-clamping connector and a mating connector. The wire-clamping connector includes a first main body that has a retaining groove, a cover, a conductive cable, and multiple first and second conductive terminals that are embedded in the first main body. The second and the first conductive terminals are opposite to each other and are in a staggered arrangement. Each of the first conductive terminals has one of multiple first upper contact portions, and each of the second conductive terminals has one of multiple second upper contact portions. The conductive cable is disposed on the first main body. The cover is disposed on the conductive cable, and is detachably fixed to the first main body. Each conductor in the conductive cable is in electrical contact with one of the first upper contact portions or one of the second upper contact portions.

### CROSS-REFERENCE TO RELATED PATENT APPLICATION

This application claims priority to the U.S. Provisional Patent Application Ser. No. 63/191,371 filed on May 21, 2021, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a wire-clamping connector assembly, and more particularly to a wire-clamping connector assembly that is adapted for automatic assembly.

### BACKGROUND OF THE DISCLOSURE

In the conventional technology, by having a connector soldered onto a circuit board (such as a PCB), a board-to-board connector is able to perform signal transmission with a conductive cable (e.g., a flexible flat cable (FFC)) through bridging of the circuit board. However, this manner of operation can increase procedures required for manufacturing the circuit board, thereby resulting in an increased manufacturing cost. Moreover, since the connector needs to be soldered onto the circuit board, such a process can be time-consuming and unfavorable for automatic assembly.

Therefore, reducing a quantity of connecting elements between the conductive cable and the board-to-board connector and simplifying a manufacturing process where the conductive cable is mated with the board-to-board connector through an improvement in the structural design, so as to overcome the above-mentioned problems, has become one of the important issues to be addressed in the related art.

### SUMMARY OF THE DISCLOSURE

In response to the above-referenced technical inadequacies, the present disclosure provides a wire-clamping connector assembly.

In one aspect, the present disclosure provides a wire-clamping connector assembly, which includes a wire-clamping connector and a mating connector. The wire-clamping connector includes a first main body, a plurality of first conductive terminals, a plurality of second conductive terminals, a conductive cable, and a cover. The first main body has a first surface and a retaining groove formed on an opposite side to the first surface. The first conductive terminals are arranged at fixed intervals and are embedded in the first main body. Each of the first conductive terminals has one of a plurality of first upper contact portions and one of a plurality of first lower contact portions, the first upper contact portions are exposed from the first surface, and the first lower contact portions are exposed in the retaining groove. The second conductive terminals are arranged at fixed intervals and are embedded in the first main body. The second conductive terminals and the first conductive terminals are opposite to each other and are in a staggered arrangement. Each of the second conductive terminals has one of a plurality of second upper contact portions and one of a plurality of second lower contact portions, the second upper contact portions are exposed from the first surface, and the second lower contact portions are exposed in the retaining groove. The conductive cable is disposed on the first main body and has a plurality of elongated conductors. The cover is disposed on the conductive cable and is detachably fixed to the first main body, such that each of the conductors is in electrical contact with one of the first upper contact portions or one of the second upper contact portions by way of crimping. The first main body, the conductive cable, and the cover are linearly assembled.

Therefore, in the wire-clamping connector assembly provided by the present disclosure, by virtue of “the cover being disposed on the conductive cable and being detachably fixed to the first main body, such that each of the conductors is in electrical contact with one of the first upper contact portions or one of the second upper contact portions by way of crimping” and “the first main body, the conductive cable, and the cover being linearly assembled,” the conductive cable can be fixed to the first main body through crimping (rather than through soldering as used in the conventional technology). By simplifying an assembly direction of the first main body, the conductive cable, and the cover in the wire-clamping connector, a manufacturing process of the wire-clamping connector can be adapted for automatic assembly.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic exploded view of a wire-clamping connector according to the present disclosure;

FIG. 2 is a schematic view showing assembly of the wire-clamping connector according to the present disclosure;

FIG. 3 is another schematic view showing assembly of the wire-clamping connector according to the present disclosure;

FIG. 4 is a schematic perspective view of the wire-clamping connector according to the present disclosure;

FIG. 5 is a schematic view showing assembly of the wire-clamping connector and a mating connector according to the present disclosure;

FIG. 6 is another schematic view showing assembly of the wire-clamping connector and the mating connector according to the present disclosure;

FIG. 7 is a schematic perspective view of a wire-clamping connector assembly according to the present disclosure;

FIG. 8 is a schematic sectional view of part VIII-VIII of FIG. 7;

FIG. 9 is a schematic top view of FIG. 8;

FIG. 10 is a schematic exploded view of the mating connector according to another embodiment of the present disclosure; and

FIG. 11 is a schematic perspective view of the mating connector according to another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Embodiments

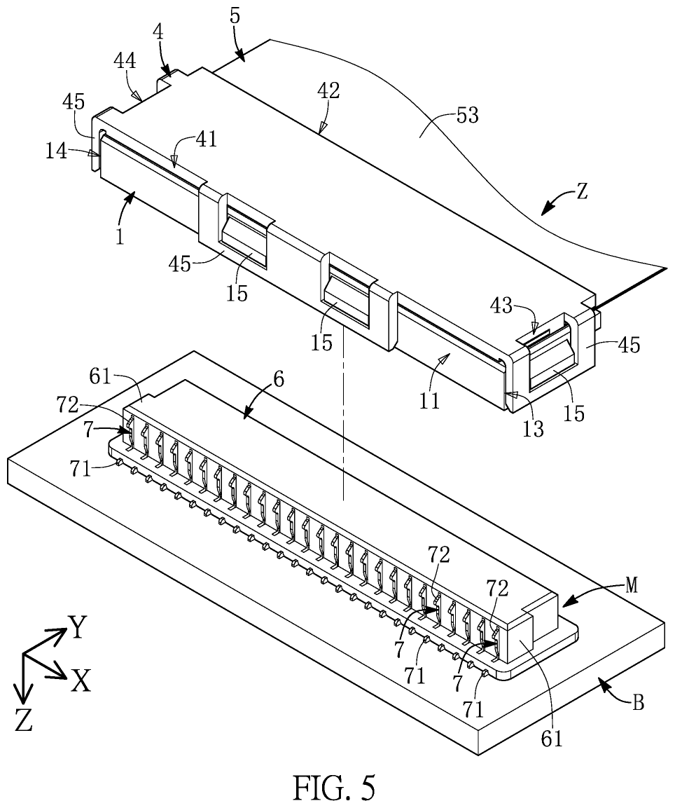

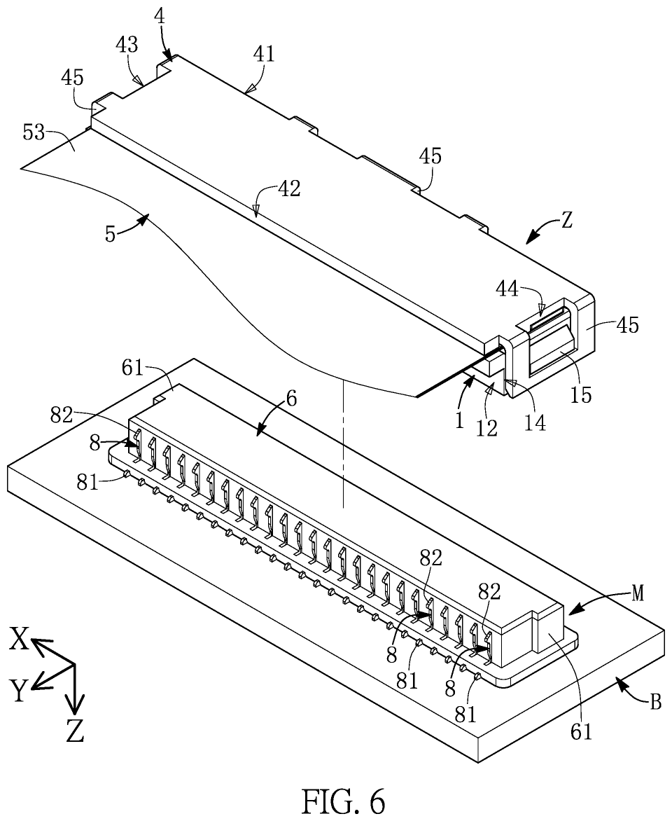

Reference is first made to FIG. 5 and FIG. 6, which are schematic views showing assembly of a wire-clamping connector and a mating connector according to the present disclosure from different angles of view. One embodiment of the present disclosure provides a wire-clamping connector assembly, which includes a wire-clamping connector Z and a mating connector M.

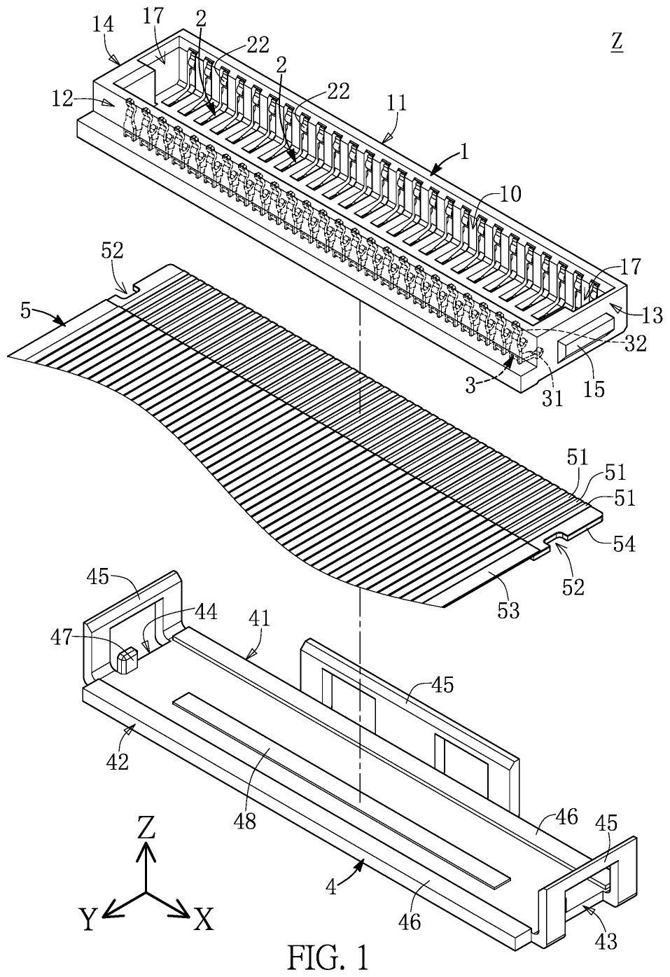

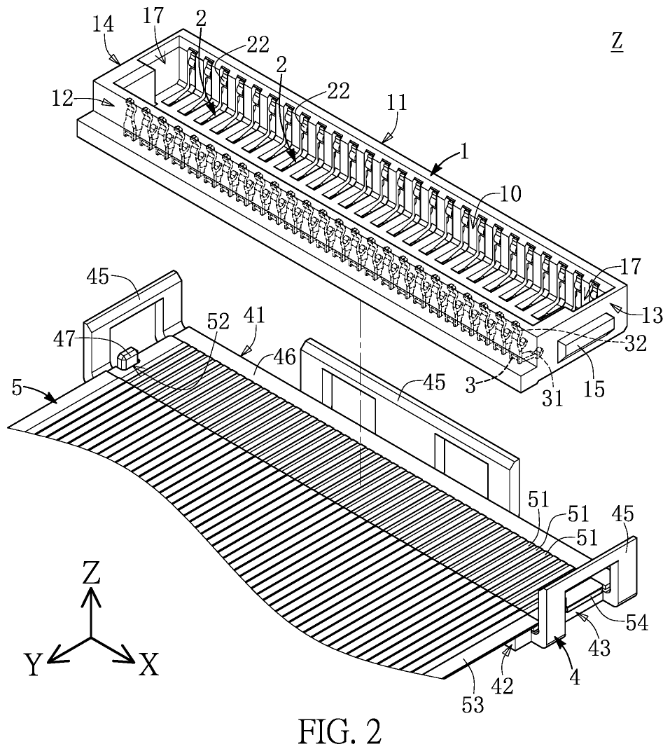

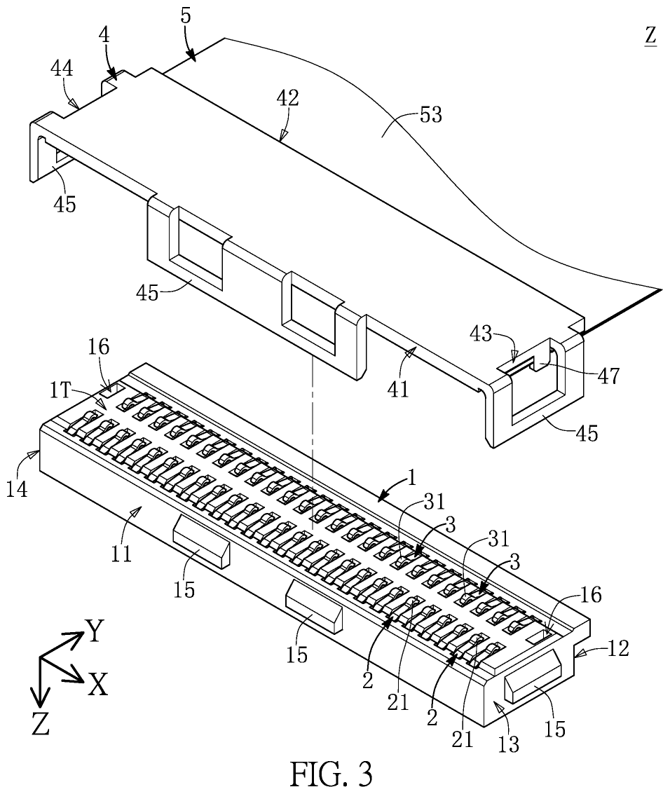

Referring to FIG. 1, FIG. 2, and FIG. 3, FIG. 1 is a schematic exploded view of the wire-clamping connector according to the present disclosure, and FIG. 2 and FIG. 3 are schematic views showing assembly of the wire-clamping connector according to the present disclosure from different angles of view. The wire-clamping connector Z includes a first main body 1, two rows of conductive terminal groups, a cover 4, and a conductive cable 5. The first main body 1 has a first surface 1T and a retaining groove 10 formed on an opposite side to the first surface 1T. The two rows of conductive terminal groups are embedded in the first main body 1, and are respectively arranged on two sides of the first main body 1. The conductive cable 5 is disposed on the first main body 1, and has a plurality of elongated conductors 51. The cover 4 is disposed on the conductive cable 5, and is detachably fixed to the first main body 1.

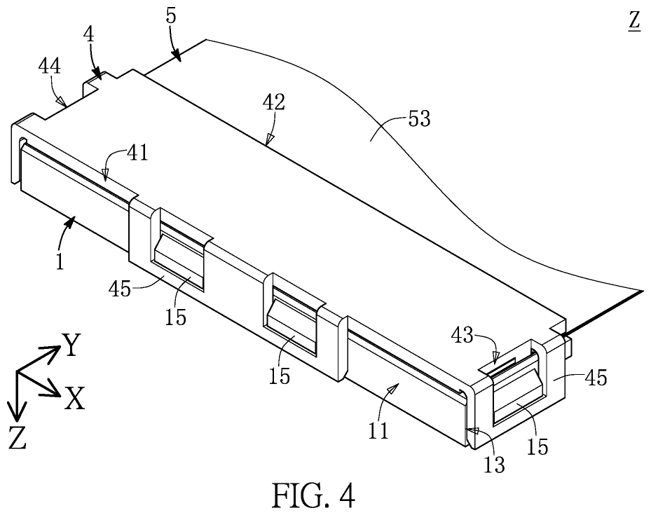

Referring to FIG. 1 to FIG. 4, FIG. 4 is a schematic perspective view of the wire-clamping connector according to the present disclosure. FIG. 1 to FIG. 4 can be taken to represent an assembly process of the wire-clamping connector. In the assembly process, the conductive cable 5 is disposed on the cover 4, and then the cover 4 and the conductive cable 5 are both disposed on the first main body 1. However, it should be noted that the first main body 1, the conductive cable 5, and the cover 4 are assembled along a straight line, and the straight line is parallel to a Z-axis. That is to say, the conductive cable 5 can first be assembled onto the cover 4 along the Z-axis, and then the cover 4 and the conductive cable 5 are disposed on the first main body 1 along the Z-axis. Accordingly, the assembly process of the wire-clamping connector Z is an assembly process that is performed in a straight line (e.g., straight up and straight down).

As shown in FIG. 2 and FIG. 3, the two rows of conductive terminal groups include a plurality of first conductive terminals 2 and a plurality of second conductive terminals 3. The first conductive terminals 2 are arranged at fixed intervals and are embedded in the first main body 1. Each of the first conductive terminals 2 has one of a plurality of first upper contact portions 21 and one of a plurality of first lower contact portions 22, the first upper contact portions 21 are exposed from the first surface 1T, and the first lower contact portions 22 are exposed in the retaining groove 10. The second conductive terminals 3 are arranged at fixed intervals and are embedded in the first main body 1. The second conductive terminals 3 and the first conductive terminals 2 are opposite to each other and are in a staggered arrangement. Each of the second conductive terminals 3 has one of a plurality of second upper contact portions 31 and one of a plurality of second lower contact portions 32, the second upper contact portions 31 are exposed from the first surface 1T, and the second lower contact portions 32 are exposed in the retaining groove 10.

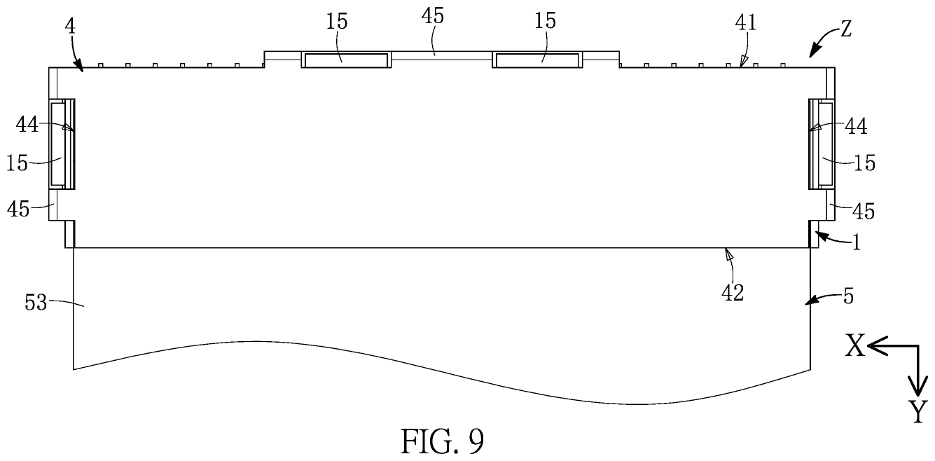

Reference is further made to FIG. 3, FIG. 4, and FIG. 9, in which FIG. 9 is a schematic top view of the wire-clamping connector assembly according to the present disclosure. The first main body 1 has a first long side 11 and a second long side 12 that are opposite to each other, and has a first short side 13 and a second short side 14 that are opposite to each other and are connected between the first long side 11 and the second long side 12. At least one protrusion 15 is formed on each of the first long side 11, the first short side 13, and the second short side 14 of the first main body 1. To be more specific, in the present embodiment, the first short side 13 and the second short side 14 each have one protrusion 15 formed thereon, and the first long side 11 has two protrusions 15 formed thereon. The cover 4 has a third long side 41 and a fourth long side 42 that are opposite to each other, and has a third short side 43 and a fourth short side 44 that are opposite to each other and are connected between the third long side 41 and the fourth long side 42. At least one engaging portion 45 that corresponds to the at least one protrusion 15 is formed on each of the third long side 41, the third short side 43, and the fourth short side 44 of the cover 4. When the cover 4, the first main body 1, and the conductive cable 5 are assembled with each other, the at least one engaging portion 45 is correspondingly engaged with the at least one protrusion 15. Therefore, in the present embodiment (as shown in FIG. 9), when the cover 4 is fixed to the first main body 1, the engaging portion 45 on the third long side 41 of the cover 4 is correspondingly engaged with the two protrusions 15 on the first long side 11 of the first main body 1. The engaging portion 45 on the third short side 43 and the engaging portion 45 on the fourth short side 44 of the cover 4 are respectively and correspondingly engaged with the protrusion 15 on the first short side 13 and the protrusion 15 on the second short side 14 of the first main body 1. However, a quantity of the protrusion 15 and a quantity of the engaging portion 45 are not limited in the present disclosure.

In continuation of the above, as shown in FIG. 1 and FIG. 2, the cover 4 further includes at least one limiting rib 46, at least one guide column 47, and a press-contact portion 48. The at least one limiting rib 46, the at least one guide column 47, and the press-contact portion 48 are disposed on a same surface of the cover 4 (i.e., a surface that faces toward the conductive cable 5 and the first main body 1 during assembly). The limiting rib 46 is arranged along an edge of the fourth long side 42 and is parallel to the fourth long side 42, and the guide column 47 is arranged in proximity to where the third short side 43 or the fourth short side 44 is positioned. In the present embodiment, both the limiting rib 46 and the guide column 47 are two in number. The two limiting ribs 46 are arranged on the third long side 41 and the fourth long side 42, respectively. The two guide columns 47 are respectively arranged in proximity to where the third short side 43 and the fourth short side 44 are positioned. However, a quantity of the limiting rib 46 and a quantity of the guide column 47 are not limited in the present disclosure. The press-contact portion 48 is arranged between the two limiting ribs 46 (or between the two guide columns 47), and is parallel to the third long side 41 and the fourth long side 42. Two sides of the conductive cable 5 have at least one groove 52 formed thereon (a quantity of the groove 52 is exemplified as two in the present disclosure), and the first main body 1 has at least one guide hole 16 (a quantity of the guide hole 16 is exemplified as two in the present disclosure). The guide hole 16 is formed on the first surface 1T, and is adjacent to the first short side 13 or the second short side 14. When the cover 4, the first main body 1, and the conductive cable 5 are assembled with each other, each guide column 47 is inserted into a corresponding one of the grooves 52 and a corresponding one of the guide holes 16.

As shown in FIG. 5 and FIG. 6, the first main body 1 further includes at least one first foolproof structure 17. The at least one first foolproof structure 17 is formed in the retaining groove 10, and is adjacent to the first short side 13 or the second short side 14 (a quantity of the first foolproof structure 17 is exemplified as two in the present embodiment). A second main body 6 further includes at least one second foolproof structure 61 that corresponds to the at least one first foolproof structure 17, and the at least one second foolproof structure 61 is formed on the third short side 43 or the fourth short side 44 (a quantity of the second foolproof structure 61 is exemplified as two in the present embodiment). When the first main body 1 is disposed over the second main body 6 via the retaining groove 10, the two first foolproof structures 17 are fitted with the two second foolproof structures 61, respectively.

Furthermore, the wire-clamping connector assembly further includes a circuit board B and a mating connector M disposed on the circuit board B. The mating connector M includes the second main body 6, a plurality of third conductive terminals 7, and a plurality of fourth conductive terminals 8. The third conductive terminals 7 and the fourth conductive terminals 8 are opposite to each other and are in a staggered arrangement. Each of the third conductive terminals 7 includes one of a plurality of first pins 71 and one of a plurality of third upper contact portions 72. Each of the fourth conductive terminals 8 includes one of a plurality of second pins 81 and one of a plurality of fourth upper contact portions 82. The first pins 71 and the second pins 81 are exposed from the second main body 6 and extend along two opposite sides of the second main body 6, so as to be soldered onto the circuit board B. The third upper contact portions 72 and the fourth upper contact portions 82 are exposed from two side surfaces of the second main body 6.

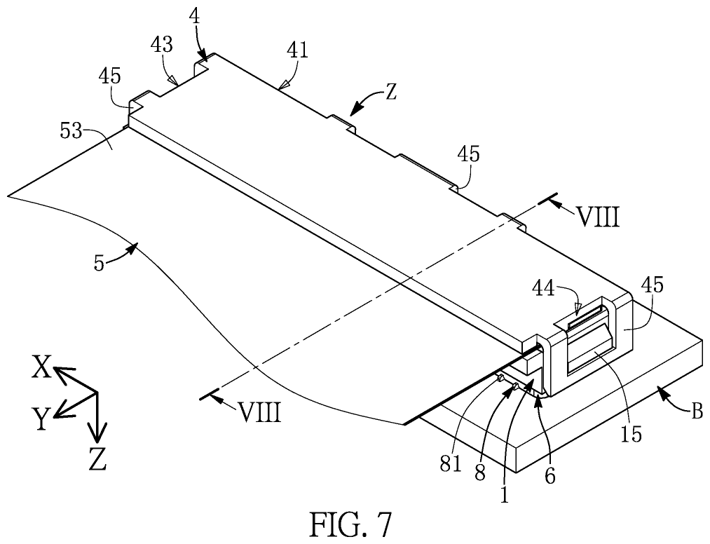

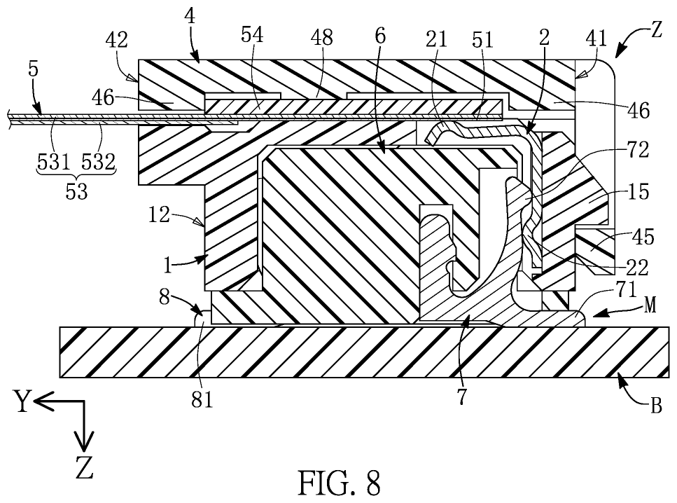

Referring to FIG. 6, FIG. 7, and FIG. 8, FIG. 7 is a schematic perspective view of the wire-clamping connector assembly according to the present disclosure, and FIG. 8 is a schematic sectional view of part VIII-VIII of FIG. 7. When the wire-clamping connector Z is mated with the mating connector M, the wire-clamping connector Z is mated with the mating connector M along a first direction (i.e., a positive Z-axis direction), the first lower contact portion 22 of each of the first conductive terminals 2 is in electrical contact with a corresponding one of the third conductive terminals 7, and the second lower contact portion 32 of each of the second conductive terminals 3 is in electrical contact with a corresponding one of the fourth conductive terminals 8. The conductive cable 5 further includes an insulating casing 53 and a reinforcing plate 54. The insulating casing 53 has an upper casing 531 and a lower casing 532. The upper casing 531 and the lower casing 532 cover each of the conductors 51 from top and from bottom, but a part of each of the conductors 51 is exposed. The reinforcing plate 54 is adhered to an outer surface of the insulating casing 53 (the upper casing 531). When the cover 4, the first main body 1, and the conductive cable 5 are assembled with each other, the press-contact portion 48 of the cover 4 presses downwardly against the reinforcing plate 54 and applies a normal downward force, such that the exposed part of each of the conductors 51 is in electrical contact with one of the first upper contact portions 21 or one of the second upper contact portions 31. In addition, as shown in FIG. 8, the reinforcing plate 54 abuts against the limiting rib 46 along a direction (i.e., a positive Y-axis direction) perpendicular to the first direction, so as to prevent the conductive cable 5 from being disengaged from the wire-clamping connector Z. When the first main body 1 is disposed over the second main body 6 via the retaining groove 10, each of the first lower contact portions 22 structurally interferes with a corresponding one of the third upper contact portions 72, and each of the second lower contact portions 32 structurally interferes with a corresponding one of the fourth upper contact portions 82.

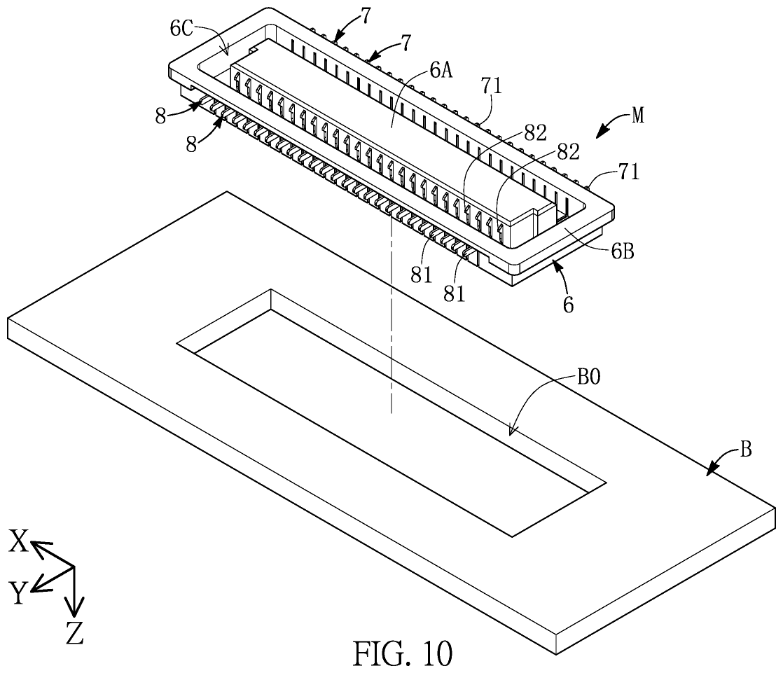

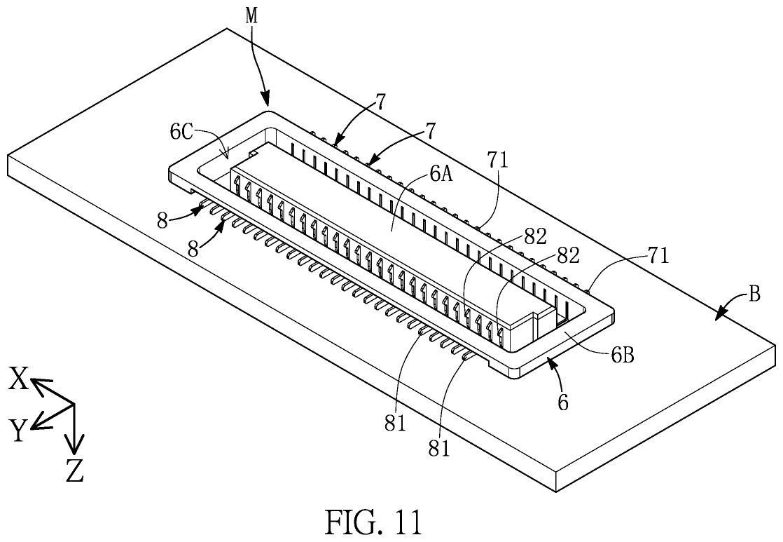

Referring to FIG. 10 and FIG. 11, FIG. 10 is a schematic exploded view of the mating connector according to another embodiment of the present disclosure, and FIG. 11 is a schematic perspective view of the mating connector according to another embodiment of the present disclosure. In FIG. 10 and FIG. 11, another configuration of the mating connector M is shown. A comparison between the mating connector M in FIG. 5 and FIG. 7 and the mating connector M in FIG. 10 and FIG. 11 shows that that the circuit board B in FIG. 10 and FIG. 11 is formed with a groove hole B0, and the mating connector M is fitted into the groove hole B0. The mating connector M includes the second main body 6, the plurality of third conductive terminals 7, and the plurality of fourth conductive terminals 8. The third conductive terminals 7 and the fourth conductive terminals 8 are opposite to each other and are in a staggered arrangement. Each of the third conductive terminals 7 includes one of the plurality of first pins 71 and one of the plurality of third upper contact portions 72. Each of the fourth conductive terminals 8 includes one of the plurality of second pins 81 and one of the plurality of fourth upper contact portions 82. The second main body 6 includes a central protruding portion 6A, an outer peripheral wall 6B surrounding the central protruding portion 6A, and a ring-shaped groove 6C that is formed between the central protruding portion 6A and the outer peripheral wall 6B. The first pins 71 and the second pins 81 are exposed from two side surfaces of the outer peripheral wall 6B and are soldered onto the circuit board B. The third upper contact portions 72 and the fourth upper contact portions 82 are exposed from two side surfaces of the central protruding portion 6A.

It should be noted that, in the embodiment of FIG. 10 and FIG. 11, the structure of the wire-clamping connector Z is the same as that of the previous embodiment, which is thus not illustrated in FIG. 10 and FIG. 11. The structure of the wire-clamping connector Z will not be repeated herein. The mating connector M of FIG. 11 can substitute for the mating connector M of FIG. 6, and the wire-clamping connector Z can be mated with the mating connector M along the first direction (i.e., the positive Z-axis direction), so that the first main body 1 is disposed over the central protruding portion 6A via the retaining groove 10, and the first main body 1 is positioned between the central protruding portion 6A and the ring-shaped groove 6C. When the wire-clamping connector Z is mated with the mating connector M, the first lower contact portion 22 of each of the first conductive terminals 2 is in electrical contact with a corresponding one of the third conductive terminals 7, and the second lower contact portion 32 of each of the second conductive terminals 3 is in electrical contact with a corresponding one of the fourth conductive terminals 8. Moreover, when the first main body 1 is disposed over the central protruding portion 6A via the retaining groove 10, each of the first lower contact portions 22 structurally interferes with a corresponding one of the third upper contact portions 72, and each of the second lower contact portions 32 structurally interferes with a corresponding one of the fourth upper contact portions 82.

### [Beneficial Effects of the Embodiments]

In conclusion, in the wire-clamping connector assembly provided by the present disclosure, by virtue of “the cover 4 being disposed on the conductive cable 5 and being detachably fixed to the first main body 1, such that each of the conductors 51 is in electrical contact with one of the first upper contact portions 21 or one of the second upper contact portions 31 by way of crimping” and “the first main body 1, the conductive cable 5, and the cover 4 being linearly assembled,” the conductive cable 5 can be fixed to the first main body 1 through crimping (rather than through soldering as used in the conventional technology). By simplifying an assembly direction of the first main body 1, the conductive cable 5, and the cover 4 in the wire-clamping connector Z, a manufacturing process of the wire-clamping connector Z can be adapted for automatic assembly.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A wire-clamping connector assembly, comprising:
a wire-clamping connector, wherein the wire-clamping connector includes:
a first main body having a first surface and a retaining groove formed on an opposite side to the first surface;
a plurality of first conductive terminals arranged at fixed intervals and embedded in the first main body, wherein each of the first conductive terminals has one of a plurality of first upper contact portions and one of a plurality of first lower contact portions, the first upper contact portions are exposed from the first surface, and the first lower contact portions are exposed in the retaining groove;
a plurality of second conductive terminals arranged at fixed intervals and embedded in the first main body, wherein the second conductive terminals and the first conductive terminals are opposite to each other and are in a staggered arrangement, each of the second conductive terminals has one of a plurality of second upper contact portions and one of a plurality of second lower contact portions, the second upper contact portions are exposed from the first surface, and the second lower contact portions are exposed in the retaining groove;
a conductive cable, wherein the conductive cable is disposed on the first main body and has a plurality of elongated conductors; and
a cover, wherein the cover is disposed on the conductive cable and is detachably fixed to the first main body, such that each of the conductors is in electrical contact with one of the first upper contact portions or one of the second upper contact portions by way of crimping;
wherein the first main body, the conductive cable, and the cover are linearly assembled.

2. The wire-clamping connector assembly according to claim 1, further comprising a circuit board and a mating connector disposed on the circuit board, wherein the mating connector includes a second main body, a plurality of third conductive terminals, and a plurality of fourth conductive terminals; wherein the third conductive terminals and the fourth conductive terminals are opposite to each other and are in a staggered arrangement, each of the third conductive terminals includes one of a plurality of first pins and one of a plurality of third upper contact portions, and each of the fourth conductive terminals includes one of a plurality of second pins and one of a plurality of fourth upper contact portions; wherein the first pins and the second pins are exposed from the second main body and extend along two opposite sides of the second main body, so as to be soldered onto the circuit board; wherein the third upper contact portions and the fourth upper contact portions are exposed from two side surfaces of the second main body.

3. The wire-clamping connector assembly according to claim 2, wherein the wire-clamping connector is mated with the mating connector along a first direction, and the first main body is disposed over the second main body via the retaining groove; wherein, when the wire-clamping connector is mated with the mating connector, the first lower contact portion of each of the first conductive terminals is in electrical contact with a corresponding one of the third conductive terminals, and the second lower contact portion of each of the second conductive terminals is in electrical contact with a corresponding one of the fourth conductive terminals.

4. The wire-clamping connector assembly according to claim 3, wherein the first main body has a first long side and a second long side that are opposite to each other, and has a first short side and a second short side that are opposite to each other and are connected between the first long side and the second long side; wherein at least one protrusion is formed on each of the first long side, the first short side, and the second short side of the first main body; wherein the cover has a third long side and a fourth long side that are opposite to each other, and has a third short side and a fourth short side that are opposite to each other and are connected between the third long side and the fourth long side; wherein at least one engaging portion that corresponds to the at least one protrusion is formed on each of the third long side, the third short side, and the fourth short side of the cover; wherein, when the cover, the first main body, and the conductive cable are assembled with each other, the at least one engaging portion is correspondingly engaged with the at least one protrusion.

5. The wire-clamping connector assembly according to claim 4, wherein the cover further includes at least one limiting rib and at least one guide column, the at least one limiting rib and the at least one guide column are disposed on a surface of the cover, the at least one limiting rib is arranged along an edge of the fourth long side and is parallel to the fourth long side, and the at least one guide column is arranged in proximity to where the third short side or the fourth short side is positioned.

6. The wire-clamping connector assembly according to claim 5, wherein two sides of the conductive cable have at least one groove formed thereon, the first main body has at least one guide hole, and the at least one guide hole is formed on the first surface and is adjacent to the first short side or the second short side; wherein, when the cover, the first main body, and the conductive cable are assembled with each other, the at least one guide column is correspondingly inserted into the at least one groove and the at least one guide hole.

7. The wire-clamping connector assembly according to claim 6, wherein the conductive cable further includes an insulating casing and a reinforcing plate, the insulating casing covers each of the conductors but a part of each of the conductors is exposed, and the reinforcing plate is adhered to an outer surface of the insulating casing; wherein, when the cover, the first main body, and the conductive cable are assembled with each other, the exposed part of each of the conductors is in electrical contact with one of the first upper contact portions or one of the second upper contact portions, and the reinforcing plate abuts against the at least one limiting rib along a direction perpendicular to the first direction.

8. The wire-clamping connector assembly according to claim 3, wherein the first main body further includes at least one first foolproof structure, and the at least one first foolproof structure is formed in the retaining groove and is adjacent to the first short side or the second short side; wherein the second main body further includes at least one second foolproof structure that corresponds to the at least one first foolproof structure, and the at least one second foolproof structure is formed on the third short side or the fourth short side; wherein, when the first main body is disposed over the second main body via the retaining groove, the at least one first foolproof structure is fitted with the at least one second foolproof structure.

9. The wire-clamping connector assembly according to claim 3, wherein, when the first main body is disposed over the second main body via the retaining groove, each of the first lower contact portions structurally interferes with a corresponding one of the third upper contact portions, and each of the second lower contact portions structurally interferes with a corresponding one of the fourth upper contact portions.

10. The wire-clamping connector assembly according to claim 1, further comprising a circuit board and a mating connector disposed on the circuit board, wherein the circuit board is formed with a groove hole, the mating connector is fitted into the groove hole, and the mating connector includes a second main body, a plurality of third conductive terminals, and a plurality of fourth conductive terminals; wherein the third conductive terminals and the fourth conductive terminals are opposite to each other and are in a staggered arrangement, each of the third conductive terminals includes one of a plurality of first pins and one of a plurality of third upper contact portions, and each of the fourth conductive terminals includes one of a plurality of second pins and one of a plurality of fourth upper contact portions; wherein the second main body includes a central protruding portion and an outer peripheral wall surrounding the central protruding portion, the first pins and the second pins are exposed from two side surfaces of the outer peripheral wall and are soldered onto the circuit board, and the third upper contact portions and the fourth upper contact portions are exposed from two side surfaces of the central protruding portion.

11. The wire-clamping connector assembly according to claim 10, wherein the wire-clamping connector is mated with the mating connector along a first direction, and the first main body is disposed over the central protruding portion via the retaining groove; wherein, when the wire-clamping connector is mated with the mating connector, the first lower contact portion of each of the first conductive terminals is in electrical contact with a corresponding one of the third conductive terminals, and the second lower contact portion of each of the second conductive terminals is in electrical contact with a corresponding one of the fourth conductive terminals.

12. The wire-clamping connector assembly according to claim 11, wherein the first main body has a first long side and a second long side that are opposite to each other, and has a first short side and a second short side that are opposite to each other and are connected between the first long side and the second long side; wherein at least one protrusion is formed on each of the first long side, the first short side, and the second short side of the first main body; wherein the cover has a third long side and a fourth long side that are opposite to each other, and has a third short side and a fourth short side that are opposite to each other and are connected between the third long side and the fourth long side; wherein at least one engaging portion that corresponds to the at least one protrusion is formed on each of the third long side, the third short side, and the fourth short side of the cover; wherein, when the cover, the first main body, and the conductive cable are assembled with each other, the at least one engaging portion is correspondingly engaged with the at least one protrusion.

13. The wire-clamping connector assembly according to claim 12, wherein the cover further includes at least one limiting rib and at least one guide column, the at least one limiting rib and the at least one guide column are disposed on a surface of the cover, the at least one limiting rib is arranged along an edge of the fourth long side and is parallel to the fourth long side, and the at least one guide column is arranged in proximity to where the third short side or the fourth short side is positioned.

14. The wire-clamping connector assembly according to claim 13, wherein two sides of the conductive cable have at least one groove formed thereon, the first main body has at least one guide hole, and the at least one guide hole is formed on the first surface and is adjacent to the first short side or the second short side; wherein, when the cover, the first main body, and the conductive cable are assembled with each other, the at least one guide column is correspondingly inserted into the at least one groove and the at least one guide hole.

15. The wire-clamping connector assembly according to claim 14, wherein the conductive cable further includes an insulating casing and a reinforcing plate, the insulating casing covers each of the conductors but a part of each of the conductors is exposed, and the reinforcing plate is adhered to an outer surface of the insulating casing; wherein, when the cover, the first main body, and the conductive cable are assembled with each other, the exposed part of each of the conductors is in electrical contact with one of the first upper contact portions or one of the second upper contact portions, and the reinforcing plate abuts against the at least one limiting rib along a direction perpendicular to the first direction.

16. The wire-clamping connector assembly according to claim 11, wherein the first main body further includes at least one first foolproof structure, and the at least one first foolproof structure is formed in the retaining groove and is adjacent to the first short side or the second short side; wherein the second main body further includes at least one second foolproof structure that corresponds to the at least one first foolproof structure, and the at least one second foolproof structure is formed on the two side surfaces of the central protruding portion; wherein, when the first main body is disposed over the central protruding portion via the retaining groove, the at least one first foolproof structure is fitted with the at least one second foolproof structure.

17. The wire-clamping connector assembly according to claim 11, wherein, when the first main body is disposed over the central protruding portion via the retaining groove, each of the first lower contact portions structurally interferes with a corresponding one of the third upper contact portions, and each of the second lower contact portions structurally interferes with a corresponding one of the fourth upper contact portions.
